(19) United States
(12) Patent Application Publication
(10) Pub. No.: US 2009/0055325 A1
(43) Pub. Date: Feb. 26, 2009

(54) System and method for an interactive analysis and information sharing platform for trading securities

(76) Inventors: Avshalom Leventhal, Ra'anana (IL); Ran Levy, Herzliya (IL)

Correspondence Address: DR. D. GRAESER LTD., 9003 FLORIN WAY, UPPER MARLBORO, MD, 20772, US

(21) Appl. No.: 12/219,467

(22) Filed: Jul. 23, 2008

Related U.S. Application Data
(60) Provisional application No. 60/935,081, filed on Jul. 25, 2007.

(51) Int. Cl. G06Q 40/00

(52) U.S. Cl. 705/36 R

(57) ABSTRACT

A system and a method for an interactive analysis platform for trading securities which combines a plurality of different types of analytical information in a chart presented in a graphical display. The system provides the ability to form a community of traders as well as virtual trading room. At least one type of information provided in the graphical display relates to quotes for the securities being traded while at least one other type of information provided is an analysis of trading information. Preferably the analysis of trading information includes inputs from securities traders. Preferably, the securities being traded are related to currency, such as for example FOREX trades. For the purpose of description only and without wishing to be limited in any way, the discussion below centers around traded securities that are related to currency, although it should be noted that according to some embodiments, the present invention may also optionally be applied to stocks, bonds or any other type of security. The interactive platform preferably provides such combined information at least as a decision making tool (although as described in greater detail below, according to at least some embodiments of the present invention, execution of one or more trades is also supported).

This Application claims priority from U.S. Provisional Application No. 60/935,081, filed on 25 Jul. 2007 hereby incorporated by reference as if fully set forth herein.

### FIELD OF THE INVENTION

The present invention relates to a system and a method for an interactive analysis platform for trading securities, and in particular, to such a system and method which includes inputs from other traders directly in the analysis in an interactive manner

### BACKGROUND OF THE INVENTION

The Internet has enabled computer users all over the world to interact and communicate electronically. Such electronic communication supports trading in currencies, stocks, commodities and some of the newer forms of securities such as derivatives and the like (herein collectively termed “securities trading”), as opposed to the traditional trading “floor”, in which traders would need to be physically present in order to place buy and sell orders. Now traders can be located anywhere in the world and can trade in many different securities on any number of trading boards and/or exchanges.

However, this flexibility also makes it increasingly difficult to communicate with other traders and to exchange ideas. Direct, person to person, interactions have been replaced by virtual interactions, for example through message boards or virtual forums. Unfortunately these interactions restrict the exchange of information and ideas, and also do not permit current data available to traders to be easily linked to communicated messages or information between traders.

Analysis tools which are available may provide various types of mathematically based analyses of securities trends and/or other trading information. Some of these tools enable traders to easily view certain types of information as separate graphs or views; however they do not combine multiple types of analyses in an interactive manner in real time and fail to encourage traders to share information and analysis inputs, thereby restricting the ease of comparison and integration between these different types of information.

### SUMMARY OF THE INVENTION

There is an unmet need for, and it would be highly useful to have, a system and a method for an interactive and information sharing analysis platform for trading securities which combines a plurality of different types of analytical information in a graphical display.

There is also an unmet need for, and it would be highly useful to have, such a system and a method which would include inputs from actual securities traders, such as for example currency or FOREX traders, in an interactive manner with the graphical display.

There is also an unmet need for, and it would be highly useful to have, such a system and a method which would provide control over privacy by optionally and preferably avoiding the disclosure of information regarding funds in the traders' accounts and the size of their positions. There is also an unmet need for, and it would be highly useful to have, such a system and a method which preferably enable the trader to choose with whom and when to share his trading activity information.

The present invention overcomes these drawbacks of the background art by providing a system and method for an interactive analysis platform for trading securities and in particular Forex, which combines a plurality of different types of analytical information in a graphical display. At least one type of information provided in the graphical display relates to quotes for the securities being traded while at least one other type of information provided is an analysis of trading information. Preferably the analysis of trading information includes inputs from securities traders. For example, such inputs may optionally include but are not limited to their market expectations or the plurality of positions taken by a group of traders before their trades actually take place and/or after one or more trades have occurred. Preferably, the securities being traded are related to currency, such as for example FOREX trades. More preferably, the analysis platform provides such information in real time.

The foreign exchange (currency or forex or FX) market exists wherever one currency is traded for another. It is by far the largest financial market in the world, and includes trading between large banks, central banks, currency speculators, multinational corporations, governments, and other financial markets and institutions, as well as individuals. The foreign exchange market is unique (as compared to markets for other types of securities) for many reasons, some of which include its trading volume, the extreme liquidity of the market, the large number of, and variety of, traders in the market, its geographical dispersion, its long trading hours—24 hours a day (except on weekends) and the variety of factors that affect exchange rates.

According to one embodiment of the present invention the system and method can optionally enable a trader to consider whether to purchase or subscribe to trading information from at least one other trader. Such a process may optionally be an ad hoc event, or alternately based on a long term engagement, in which the information is electronically transferred from one trader to one or more traders. This embodiment can help traders who are not experienced in the market to perform better trading. According to this embodiment traders are preferably ranked according to the performance of their trading. The ranking is constructed, optionally and preferably, by aggregating statistical information about the performance of each trader Traders are preferably and optionally categorized according to their trading behavior. According to this method a trader who is interesting in buying information from another trader will also consider the trading behavior when choosing the trader from which the information is purchased.

By “securities” it is meant currencies, stocks, commodities and any of the newer forms of securities such as derivatives and the like.

By “trade” it is meant both the actual act of trading (for example exchanging dollars for Euros) and also a “position” in a particular security (for example exchanging dollars for Euros and holding the Euros for a lo particular period of time).

By “electronic communication” it is meant any type of communication between two or more human beings through an electronic device and/or mechanism, including without limitation voice, data, e-mail, instant messaging or any other peer to peer messaging, posting a message on an electronic forum or board, transmitting a message through any type of message server, entering a message through a Web page or any other type of mark-up language document, or any type of on-line communication, including without limitation any type of transmission related to mark-up language documents such as browsing through cellular telephones, computers, personal data assistants and the like.

By “online”, it is meant that communication is performed through an electronic communication medium, including but not limited to, telephone voice communication through the PSTN (public switched telephone network), cellular telephones, voice over IP (VoIP) or a combination thereof; exchanging information through Web pages according to HTTP (HyperText Transfer Protocol) or any other protocol for communication with and through mark-up language documents; exchanging messages through e-mail (electronic mail), messaging services such as ICQ™ for example, and any other type of messaging service; any type of communication using a computational device as previously defined; as well as any other type of communication which incorporates an electronic medium for transmission.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual lo instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary system according to the present invention;

FIG. 2 is a flowchart of an illustrative method according to the present invention; and

FIGS. 3-5 show exemplary GUI screenshots for some embodiments of an interactive trading platform according to the present invention.

FIG. 6 shows an exemplary scenario for ranking a trader.

### DESCRIPTION OF THE PREFERRED EMBODIMENTS

The present invention is of a system and method for an interactive analysis platform for trading securities which combines a plurality of different types of analytical information in a graphical display. At least one type of information provided in the graphical display relates to quotes for the securities being traded while at least one other type of information provided is an analysis of trading information. Preferably the analysis of trading information includes inputs from securities traders. Preferably, the securities being traded are related to currency, such as for example FOREX trades. For the purpose of description only and without wishing to be limited in any way, the discussion below centers around traded securities that are related to currency, although it should be noted that according to some embodiments, the present invention may also optionally be applied to stocks, bonds or any other type of security. The interactive platform preferably provides such combined information at least as a decision making tool (although as described in greater detail below, according to at least some embodiments of the present invention, execution of one or more trades is also supported).

According to some embodiments of the present invention, the input from other traders of securities is preferably obtained from an individual or a lo group of such traders. Preferably, one or more such traders in the group are able to view input from one or more other traders in the group. Such input may optionally be viewed in combination with a display of information and/or data about one or more securities. For example, for currency trading, a frequent type of information display is one or more analytic graphs, (such as “candlestick” graphs). According to some embodiments of the present invention, the input from one or more traders may optionally be superimposed on, displayed with or otherwise combined with one or more analytic graphs. Such input may optionally comprise a buy or sell order, or any other information related to a trade, a text message, a graphical message, a voice message, any type of combination message (featuring at least two of text, graphic or voice information) or any other combination thereof. Such input may also optionally include analyzed input, including but not limited to a number of short/long orders for a particular security or type of security, activity or activities by a particular trader in the group (whether identified or anonymous), whether one or more indicators have reached a limit and/or are below/above a limit, current status of the orders for taking profits and/or stopping losses, a trader's rating and so forth.

The input may also optionally be filtered by a user (ie a trader who is using the interactive platform according to the present invention). For example, the group may assign a “rating” to individual traders, and each trader may choose to view input only from one or more traders that have at least a minimum rating. Alternatively, a trader can choose to view inputs from the entire group of traders and/or (alternatively or additionally) may choose to view input from different groups defined for example according to one or more trader preferences: friends, rating, specialty, and so forth.

According to some embodiments, such input is preferably provided through an interaction engine, which is preferably a real-time interaction engine. Such an engine optionally and preferably at least combines but more preferably analyzes input from at least one and most preferably a plurality of traders. The interaction engine also preferably filters such input, more lo preferably according to a request of the trader viewing the display, for example according to individuals (if they wish to be identified), or one or more categories. Such categories may optionally include for example different skill levels—beginners, experienced, “gurus”; alternatively or additionally, such categories may optionally be related to a type of security, country of origin, preferred language and the like.

According to some embodiments, optionally and preferably, at least one type of analytical information provided to and/or by the interactive platform comprises at least one input related to externally obtained data or information, for example with regard to one or more indicators, and/or an external news feed. Such one or more indicators may optionally include but are not limited to RSI (relative strength indicator), Stoch, force, EMA, Fibonacci, Bolingar, CCI mathematic and/or interaction indicators and the like. Optionally and more preferably, a member of a virtual trading room may filter one or more indicators (see below for a more detailed description). Optionally and most preferably, a trader may define and create one or more indicators based on the relevant filtered and/or mapped information. The mapped information could optionally include bi-directional market information, for example regarding information from a plurality of sources.

As a non-limiting example, RSI is a frequently used indicator in securities trading, including for currency trading. It may optionally be computed for a single currency or for a plurality of currencies.

Each of the above indicators may optionally have another dimension added to the indicator (for example by changing the indicator formula and/or producing a new indicator). For example, optionally the RSI calculation could be changed by choosing the trading group data or weight according to which the calculation is adjusted, and/or by using a multiplier of some type.

Another non-limiting example of an indicator is Ratio Analysis, which is the use of a ratio to compare the relative strength between any two entities. For example, an individual stock divided by the S&P (Standard and Poor) 500 index can determine whether that stock is outperforming or to underperforming the stock market as a whole. A rising ratio indicates that the numerator in the ratio is outperforming the denominator. Trend analysis (as is known in the art) can be applied to the ratio line itself to determine important turning points as another non-limiting example of an indicator.

Yet another non-limiting example of a type of indicator is one obtained by adding one or more types of information not currently available in a FOREX data feed. For example in the inter-bank structure, there is no data feed of turnover of prices or number of traders. Such data could optionally be used to create an indicator and/or could be added to an existing indicator in order to obtain a new indicator. A non-limiting example is distribution tendencies, which is related to money flow or turnover within the trading community for example.

Still another non-limiting example of an indicator is a Chaikin Money Flow (CMF) indicator. The indicator's duration may optionally be determined according to any number of periods.

Yet another non-limiting example of a type of indicator is one obtained by combining one or more indicators, for example according to an “IF/THEN” statement.

According to other embodiments of the present invention, the system and method supports the creation and analysis of social indicators; as opposed to a mathematical indicator which is calculated based on past quotes and provides a backwards or historical view of the total market, a social indicator is preferably calculated based on the past and current activity of a group of traders that is defined by various criteria. Optionally and preferably, the information is provided in aggregate, in an anonymous form, such that only the overall result, or social indicator, is provided. The social indicator may optionally be constructed on the basis of one or more trades and/or overall performance of one or more traders and/or any type of aggregate group. Optionally and preferably, an individual trader may construct a social indicator, based on the results of one or more other individual traders and/or aggregate group results, or a combination thereof. Optionally and more preferably, the trader may receive an alert if a social indicator crosses a certain threshold and/or achieves a certain result. Such aggregated information also provides a more in-depth view of the market.

According to other embodiments of the present invention, there is provided at least one and preferably a plurality of models as an analytical input to the interactive trading platform. A non-limiting example of such a model relates to providing market data, whether in real time or as time delayed data, for example by optionally and preferably allowing the trader to select one or more indicators to analyze the market data. Optionally the trader may select one or more currencies for which data is to be displayed. The trader may also optionally request that data be included from activities and/or trades by the traders in the group (preferably with regard to those traders who choose to share their data, for example optionally as a user “opt-in” preference) described in greater detail below. A result of such combined data is then preferably displayed to the trader, as well as optionally indicating information for one or more potential trades by the trader. Also optionally, the amount of each currency held by the trader is indicated as well. Preferably, the above types of data are combined in a display for the member, such as a GUI display for example. News information and/or other types of information may also optionally be displayed as well.

According to some other embodiments of the present invention, there is provided a method for performing statistical analyses on orders and activities by traders in the group. Such analyses would optionally and preferably enable the collective input (regarding orders and/or activities) to be considered. Optionally and preferably, such analyses would be provided at least to traders in the group although alternatively or additionally they could be provided to one or more users outside the group (for example for a subscription fee).

Optionally and preferably, one or more traders in the group could optionally receive payment through the group and/or through interactions with one or more traders in the group, including but not limited to broker referral fees and/or contests regarding securities trading. Such payments could for example optionally and preferably be made to certain traders who are known as “gurus” as a reward for sharing their trades with other traders.

According to other embodiments of the present invention, the interactive analysis platform preferably further comprises a market segmentation engine, for segmenting at least a portion of the quote information according to at least one of an interactive trader(s) input, an indicator and/or an external input.

According to other embodiments of the present invention, the interactive platform module is preferably connected to one or more broker servers, optionally and preferably via API (application programming interface), such that one or more traders could optionally and preferably place an order through more than one broker and could automatically and instantly obtain information regarding the broker transactions. Alternatively, either no connection to a broker could be provided or a connection to only one broker could be provided. It should also be noted that the interactive analysis platform may optionally be provided as a stand-alone platform.

According to still other embodiments of the present invention, there is provided a method and system for a virtual trading room, in which each trader can own a virtual trading room by inviting other traders to share trading information with him or her. The owner of the virtual trading room can optionally remove one or more members from his or her room. The person who is invited to a trader's virtual trading room is optionally and preferably asked to accept the invitation to share trading information with the owner, who in turn shares trading information with the person receiving the invitation. Each member in a virtual trading room can optionally share information with the trading room owner. The various members of the trading room preferably cannot share information between themselves through this trading room, Such a virtual trading room would enable traders to communicate electronically with the trading room owner, while (and/or in addition to and/or after) placing one or more trades, such that each trader could “see” (receive information about) trade(s) of the owner of the same virtual room, while the owner can optionally see trades of all members of his trading room as though they were together physically in a trading room.

According to other embodiments of the present invention, the system provides information regarding the overall trading performance of the VTR and the comparison of the performance of the traders in the VTR to market performance. According to this embodiment the system provides information regarding the trading information of the most important trader.

By sharing information it is meant receiving the information about the trades of the other traders and using this information, for example by performing the same trade, optionally and preferably after purchasing the trade.

Optionally, the owner may “disinvite” or remove traders from the virtual trading room. Also, an invited trader may also later request to remove him or herself from the virtual trading room.

According to other embodiments of the present invention, a group of traders can create a community. The group is optionally and preferably dynamic; members can join or leave the group at any point.

Such a community may optionally comprise a group of people with different skills and expertise, who may (for example) optionally work from different locations around the world. Also optionally the group of traders may be dispersed on a plurality of brokerage trading platforms. Such a group optionally and preferably functions as a virtual community that exchanges information about trading. The virtual community optionally and preferably provides social networking tools such as instant messaging, chats and transaction information for enabling the group members to better share information. A trader can choose to join such an existing community, create a new one or not to enter or use such a community. Optionally and preferably a trader who owns a virtual trading room can invite a trader from a community to join his VTR. Optionally and preferably, a trader may communicate privately with one or more other traders in the community (ie without having the entire group directly access the content of the communication), for example through one or more of private chat, e-mail, SMS, instant messaging and the like. Optionally and preferably the system can generate statistical information about the activity of the community and in particular information regarding the performance and the current activity of the community. Optionally and preferably online information regarding a trade or a certain company, trades of a certain trader, or trades of trader having a certain profile and/or type or category of profile can be provided on-line to a member of the virtual community,

Optionally and preferably, the present invention features one or more trading tools, including but not limited to automated trading according to one or more parameters specified by the trader, trailing stops, hedging capabilities and trading by algorithm and/or performing a plurality of trades according to a single trading order. For example, such a tool may optionally comprise a “black box trading tool” that enables a plurality of trades to be automatically performed according an algorithm. Such a black box trading tool may optionally perform even hundreds or more trades according to the trading algorithm. Such algorithm optionally and preferably takes into consideration the trades that have been performed by other traders and optionally also social indicator parameters. Such “black box trading tool” can optionally and preferably be traced and ranked by the system and be included in statistical calculation of the system, in order to enable the traders to evaluate its performances. Such a black box can optionally be included in VTRs or other groups of traders as described herein.

Optionally and preferably, one or more trades and/or other activities or behaviors of a trader in the group are analyzed in order to determine a profile. More preferably, the profile is created upon registration and updated based on the activity of the trader. The profile is used to recommend one or more tools and/or activities and/or trades to the trader. For example, a parameter for such an analysis could optionally be whether the trader is a day trader, carry trader, a trader who performs scalping trades (a scalping trade in Forex trading relates to a trading style in which positions are held for relatively short periods of time and where profits are taken after relatively small changes in the Forex market), while another parameter could optionally be trading hours (and hence potentially although not necessarily trader location): US , Europe etc. These parameters could then optionally be combined or “crossed” for a more complete picture of trader behavior. The profile can optionally and preferably be used for identifying and filtering the behavior of a group of traders for social networking, data aggregation, and the like. The profile can optionally and preferably saved as a template and can optionally be shared by other traders.

According to preferred embodiments of the present invention, there is provided a GUI (graphical user interface) for permitting a trader in the VTR and/or community member to view information and/or interact with the group and/or one or more specific traders belonging to the group It should be noted that a GUI according to some embodiments of the present invention may optionally comprise audio data, tactile data and/or any other type of interface.

Optionally, a user interface (such as a GUI for example) may be implemented for the traders in the group from an existing, separate or stand-alone trading platform, such as the platform of MetaQuotes, FXCM, Saxo Bank (Saxo Trader 2), PFG (Peregrine Financial Group) Forex and the like for example.

Optionally and preferably, a trader could receive one or more alerts for being indicated by and/or displayed on the graphical user interface. Each such alert could optionally relate to one or more of an external input, an interactive trader input and/or an indicator. For example, for a trader who is currently trading on-line (or at least available through some type of “on-line communication” as described herein) may optionally request to receive real time alerts through an available on-line communication mode, including but not limited to, e-mail, SMS, a voice call, instant messaging and so forth, in addition to or in place of receiving such an alert from the interactive platform.

According to some embodiments of the present invention, a trader is optionally able to customize one or more aspects of interactions with the interactive trading platform, preferably including customizing one or more aspects of the user interface such as the GUI for example.

According to some embodiments of the present invention, the interactive trading platform may optionally be used to train traders, for example novice traders, and/or to permit a trader to increase skill level and/or enhance one or more skills.

By “group” and “traders in the group” it is meant a plurality of users who interact with and use the interactive trading platform according to the present invention. This plurality of users may optionally form a closed group or may alternatively include any trader who uses the interactive platform. The term “trader” may optionally include any user of the interactive platform, regardless of whether the user actually executes a trade.

The principles and operation of the present invention may be better understood with reference to the drawings and the accompanying description.

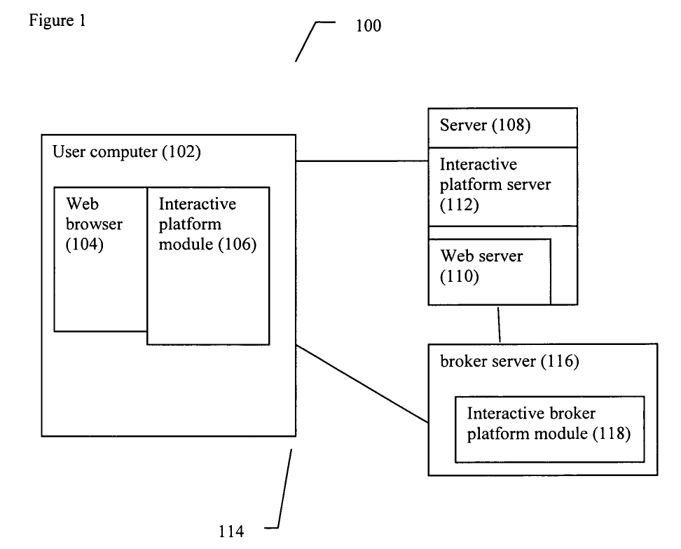

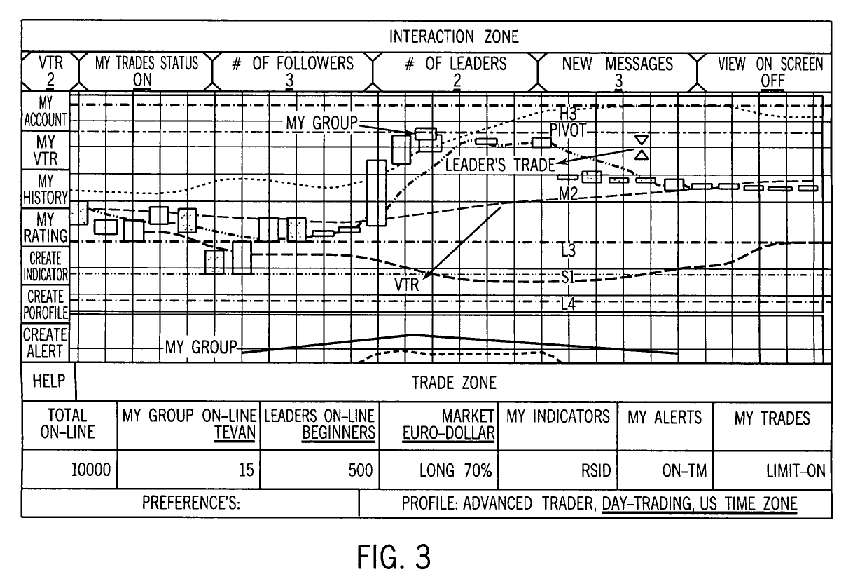

Referring now to the drawings, FIG. 1 is a schematic block diagram of an exemplary system according to some embodiments of the present invention. As shown, an exemplary system 100 features a user computer 102, which preferably operates an interactive platform module 106. Interactive platform module 106 preferably supports receipt and analysis of information, as well as the provision of such information to the user (not shown) in graphical form, more preferably through a GUI or graphical user interface (please see FIGS. 3-5 below for examples).

The GUI itself may optionally be provided directly from interactive platform module 106 and/or from a web browser 104 as shown, and through a combination thereof. For the implementation through Web browser 104, interactive platform module 106 may optionally and preferably communicate through a plug-in and/or other type of scripts and/or controls as is known in the art. Web browser 104 may also optionally be used for permitting the user to input information, for example for logging in; alternatively such information may be input through interactive platform module 106.

Additionally or alternatively, one or more technologies may optionally be used for a combination solution, for providing a Web browser-based GUI, including but not limited one or more of AJAX, Macromedia Flex and Yahoo! User interface Library, and the like as is known in the art. For such an implementation, optionally part of the user interface may be implemented on server 112, while another portion is preferably operated by user computer 102. A stand-alone user interface may also optionally be implemented through Web browser 104. Of course, a plurality of different implementation solutions may also optionally be provided for different types of computers, such as for mobile computers (including cellular telephones for example) as opposed to non-mobile or “desktop” computers for example.

Interactive platform module 106 is preferably in contact with a server 108, which is preferably in contact with such interactive platform modules 106 from a plurality of users (not shown). Server 108 preferably gathers information from each interactive platform module 106, for example optionally and preferably with regard to one or more positions taken and/or one or more trades being executed (and/or planned to be executed), more preferably including any type of information regarding the activities of traders (not shown) who use interactive platform module 106. Server 108 preferably gathers information about trades being executed from broker server 116. Communication between server 108 and broker server 116 is preferably done using a network 114, such as the internet (as described in greater detail below), by optionally and preferably using specific API (application programming interface) provided by the broker operating the broker server 116. Server 108 then preferably at least partially analyzes such information before transmitting the analyzed information to interactive platform module 106. Server 108 also optionally and preferably masks the identity of one or more traders, optionally if requested by each such trader but alternatively regardless of whether a specific request has been entered.

According to preferred embodiments, interactive platform server 112 is operated by server 108 and provides support for interactions with interactive platform module 106. Interactive platform server 112 may optionally gather information from interactive platform module 106, for example and/or may optionally perform one or more different types of analyses.

Interactive platform server 112 preferably communicates with interactive platform module 106 through network 114 which may optionally and preferably be the Internet for example (as previously described) and/or any other type of computer network (whether wireless, “wired” or a combination thereof). Optionally and more preferably, such communication is performed through a secure connection as is known in the art, for example through encryption of such communications, through HTTPS (secure hyper text transfer protocol) and/or any other known method.

Optionally and preferably, periodically interactive platform module 106 informs interactive platform server 112 as to one or more activities of the trader (user) operating and/or interacting with interactive platform module 106. For example, such information may optionally be sent according to elapsed time since the last provision of information, time of day (optionally relative to the hours of operation of one or more currency exchanges), any time an activity is performed by the trader, each time a particular activity (and/or category of activity) is performed by the trader, according to a preference set by the trader, and the like and/or any combination thereof. Such information may optionally be “pulled” by interactive platform server 112 or “pushed” by interactive platform module 106 as is known in the art.

According to some embodiments of the present invention, interactive platform server 112 and interactive platform module 106 may optionally communicate according to HTTP (hypertext transfer protocol) and/or any other such Web based communication. Under such an implementation, interactive platform server 112 may optionally communicate with interactive platform module 106 through a Web server 110 for example as shown. Web server 110 may also optionally communicate directly with web browser 104, for example for filtering and/or transmitting information.

According to some embodiments of the present invention, interactive platform module 106 may optionally communicate with one or more broker servers simultaneously 116 as shown (additionally or alternatively, interactive platform server 112 may communicate with broker server 116). Broker server 116 preferably provides brokerage services, more preferably for electronic trading or “e-trading”. Optionally, the user may access such brokerage services through interactive platform module 106 as provided by communication with broker server 116. For such an implementation, preferably interactive platform module 106 communicates with an interactive broker platform module 118, for example for optionally permitting direct trades and/or handling of positions. Broker server 116 also preferably communicates with server 108.

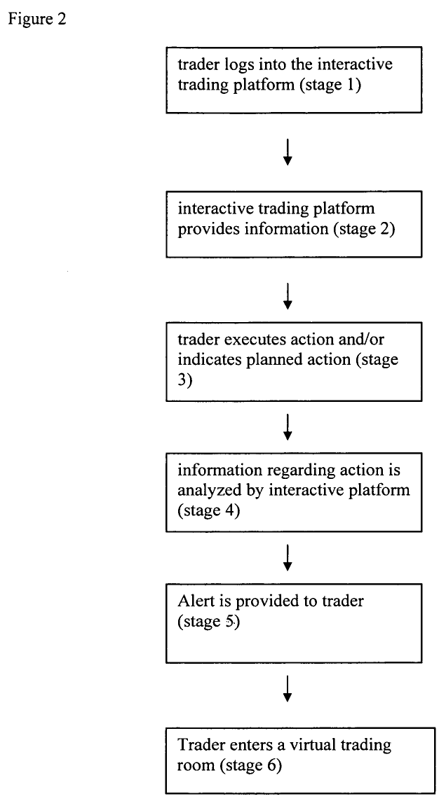

FIG. 2 is a flowchart of an illustrative method according to some embodiments of the present invention. In stage 1, a trader logs into the interactive trading platform, preferably by providing some type of identifiers such as a user name and password, but optionally also (additionally or alternatively) featuring a biometric identifier, such as a fingerprint for example.

In stage 2, the interactive trading platform provides information to the trader as described herein, for example optionally and preferably including information about one or more trades and/or positions held by other trader(s). At this stage information from a broker, such as price quotes, can also be received and optionally provided to the trader, for example on a graph or other user interface, optionally and preferably in combination with other types of information.

In stage 3, the trader optionally executes an action and/or indicates a planned action, for example with regard to a trade and/or a position.

In stage 4, information regarding the executed and/or planned action is analyzed by the interactive platform; optionally further information is sent to one or more other traders.

In stage 5, due to some type of received information by the interactive platform (whether from an external source and/or from an action by another trader), an alert is provided to the trader.

In stage 6, the trader enters a virtual trading room to interact with one or more other traders, for example to optionally and preferably view one or more traders' information and optionally to share the user's trade(s) with one or more traders that are allowed to view this information (as previously described, the sharing may optionally be limited by type) It should be noted that apart from logging in, the above stages may optionally be performed in any order.

FIG. 3 shows an exemplary illustrative GUI (graphical user interface). The GUI comprises a central graph, showing quote information (in this case currency information, for the purposes of description only and without any intention of being limiting in any way). At the top of the GUI, various types of information are optionally given, such as the number of accessible virtual trading rooms (VTR); the ability of others to view one or more trades by the user; the number of followers looking to that user as a leader; the number of leaders for that user; the number of new messages; and “view on screen”. The latter preferably refers to a mode of viewing, for example optionally the user may choose to see the data on screen as a graph and/or in table format, or according to any other mode, for example.

On the left hand side of the screen, the user may access the user's account, VTR, history and rating; or create an indicator, profile or alert.

Within the GUI display window, in addition to showing the quote information, the level of resistance from traders in the VTR is shown with the notation “VTR”. If there is more than one level of resistance (for example from more than one VTR), then each may optionally be indicated individually and/or with a different symbol, color and so forth, and/or the user may optionally choose to only view one such level of resistance at a time.

A position held by a particular leader is preferably marked with “leader's trade” as shown. The position of the group of the trader, shown as “my group” is indicated within the Japanese candlestick notation as an example only. The user may optionally and preferably choose to personalize the graphic tool(s) according to any desired parameter(s), for example according to the type of information shown, how it is shown and so forth.

On the bottom (under “trade zone”), the user has a single indicator (under “my indicators”) which is RSID; this is also shown graphed at the bottom for the user's group as well as for the externally determined RSID indicator. The “trade zone” also preferably indicates positions held by the user, the name of the user's group, the user's level, the market, any alerts and so forth.

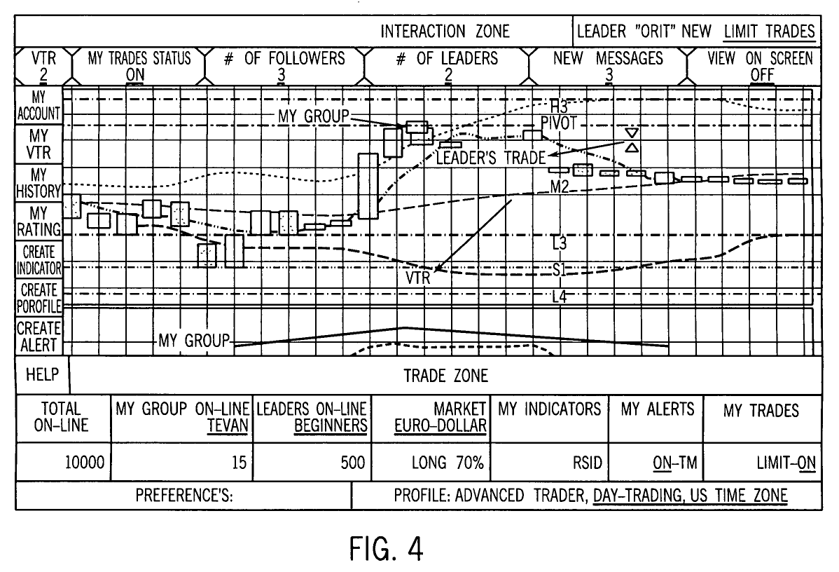

FIG. 4 shows that the user has received a new alert (at the upper right hand corner) which the user may then choose to implement (for example as a limit to trading).

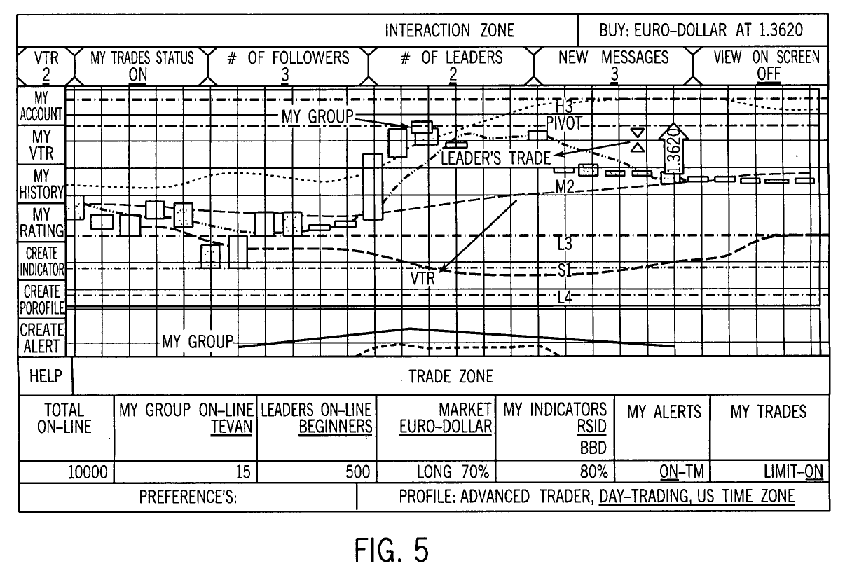

FIG. 5 shows that the user has received a particular limit alert (again at the upper right hand corner) which the user has implemented; the limit is shown marked with the vertical line on the right hand side of the graph.

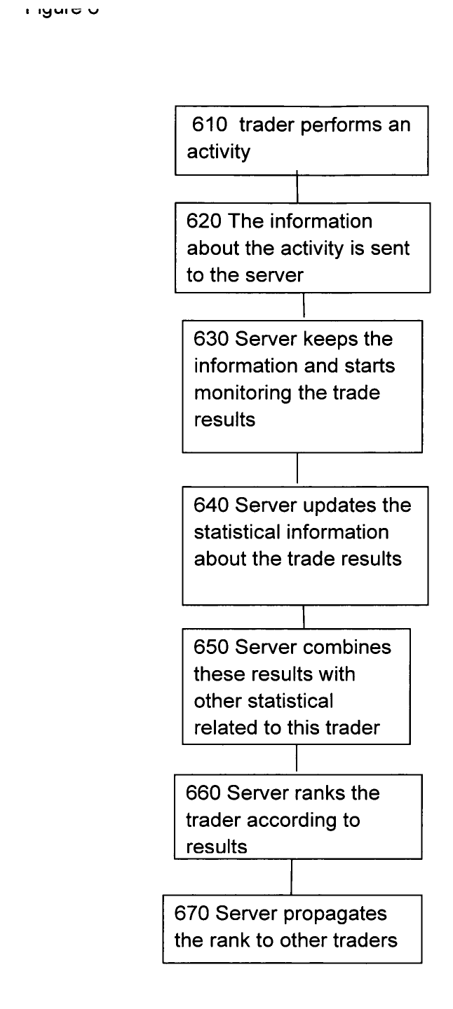

FIG. 6 shows an exemplary scenario for ranking a trader. According to one embodiment of the present invention the system and method can rank traders according to their performance. The ranking, which is based on the individual performance, creates accountability of traders. Traders which are highly ranked can optionally share with or sell their trading information to others. Whenever a trader performs an activity (610), the information regarding the activity is sent from the interactive platform module to the interactive platform server (620). Per each trade the server monitors the trade results; for example if the trading was purchasing a certain currency, the server monitors the change of the currency rate (630). The server periodically calculates statistical information about the trade and ranks the trade according to the statistical results (640). Then the server combines the results with other statistical results related to the trader (650). Then the server preferably ranks the trader, and trader groups according to the latest trades performed by this trader (660). The server then propagates the results to all the other traders (670). This information enables the traders to compare personal trader performance with group performance and market performance. Such information is called a social indicator; as opposed to a mathematical indicator which is calculated based on past quotes and provides a backwards or historical view of the market, a social indicator is preferably calculated based on the past and current activity of a group of traders that is defined by various criteria.

While the invention has been described with respect to a limited number of embodiments, it will be appreciated that many variations, modifications and other applications of the invention may be made.

What is claimed is:

1. A method for providing information to a trader of a security,
comprising combining information from at least one additional trader with quote information about the security.

2. The method of claim 1 wherein said information is automatically
collected from one or more brokers.

3. The method of claim 1, further comprising:
a. performing a statistical analysis on trading activity by said at least one additional trader; and
b. Providing automatic trading execution upon request, based on said statistical analysis.

4. The method of claim 1 wherein the input from one or more said traders is superimposed on, displayed with or otherwise combined with one or more analytical charts.

5. The method of claim 1 wherein the input comprises a buy or sell order, or any other information related to a trade, a text message, a graphical message, a voice message and any type of combination message featuring at least two of text, graphic or voice information.

6. The method of claim 1 wherein the input is combined with externally obtained data or information.

7. The method of claim 6 wherein said input is filtered by a user.

8. The method of claim 1, further comprising forming a virtual trading room by a trading owner, comprising inviting at least one other trader to share trading information with said trading owner.

9. The method of claim 8 wherein at adding least one said other trader entails the active acceptance of at least said other trader.

10. The method of claim 8 wherein at adding least one said other trader does not entail the active acceptance of at least said other trader.

11. The method of claim 8 wherein said trading owner grants at least one permission to at least one other trader to view at least one activity of said trading owner and wherein said other trader grants at least one permission to said owner to view at least one activity of said owner trading.

12. The method of claim 8 wherein performance parameters are calculated for said virtual trading room.

13. The method of claim 8 wherein trade information is analyzed and exchanged through a social networking tool.

14. The method of claim 8 wherein automatic trading execution can be a member of said virtual trading room.

15. The method of claim 1 wherein at least two traders form a group in which trade information is analyzed and exchanged through social networking tools.

16. The method of claim 15 wherein an automatic trading execution algorithm is a member of said group.

17. The method of claim 15 wherein said traders may join or leave said group on their own.

18. The method of claim 15 wherein one or more trader groups can view input of one or more other trade group.

19. The method of claim 15 wherein said trader selects whether to view input from the entire said group of traders or from specific traders in said group.

20. The method of claim 15 wherein social indicator is provided for said group of traders or for said trader, or a combination thereof.

21. The method of claim 15 wherein a trader from said trading group can communicate privately with another trader from said virtual trading group.

22. The method of claim 8 wherein real time information regarding a trade or a trader or a company is provided to at least one trader of said trading group.

23. The method of claim 1 wherein said trader is assigned a profile which is based on one or more trading activities.

24. The method of claim 23 wherein said profile is generated by said trader.

25. The method of claim 15 wherein said group is assigned a profile which is based on one or more trading activities.

26. The method of claim 1 wherein ranking is assigned to individual traders and wherein information regarding trades of said individual traders is filtered according to said ranking.

27. The method of claim 1 wherein information of at least one trader is available upon provision of one or more of payment to said trader, subscription payment to said trader, subscription payment to a service for providing trading information for one or more traders, or non-monetary acknowledgement of a contribution.

28. The method of claim 1 wherein alerts related to one or more of an external input, an interactive trader input and/or indicator are provided.

29. The method of claim 1, wherein said security comprises a currency market based security, a stock market based security or an option or derivative based security.

30. The method of claim 1 wherein said sharing information further comprises following trades of other traders.

31. The method of claim 8 wherein a trader from said virtual trading room can communicate privately with another trader from said virtual trading room.

32. A system for an interactive trading platform for trading a security, comprising:
a. a user computer for interacting with a user;
b. an interactive platform module for being operated by said user computer for receiving analyzing and provisioning of information received from interactive platform and at least one broker server and for transferring user trading information to interactive platform;
c. A server for gathering and analyzing trading information; and
d. An interactive platform server for being operated by said server for sending information to said interactive trading module, said information comprising information from at least one additional trader with quote information about the security.
e. A broker server for providing brokerage services for electronic trading or e-trading.

33. The system of claim 32 wherein said interactive platform module communicates with said interactive server through a computer network.

34. The system of claim 32 wherein said computer network is either wired or wireless.

35. The system of claim 32 wherein said interactive platform module communicates with said broker server through a computer network.

36. The system of claim 33 wherein said computer network is either wired or wireless.

37. The system of claim 32, wherein said interactive platform module interacts with a plurality of different broker servers.

38. The system of claim 37, wherein said interactive platform comprises a plurality of different interfaces, each interface being configured for interacting with a different broker server.

39. The system of claim 32, wherein said security comprises a currency market based security or a stock market based security.

40. The system of claim 32 wherein said analysis server interacts with said broker server through a computer network.

41. The system of claim 40 wherein said computer network is either wired or wireless.

42. The system of claim 32 wherein said analysis server communicates with plurality of broker servers through a computer network.

43. The system of claim 42 wherein said computer network is either wired or wireless.

44. The method of claim 11, further comprising providing one or more privacy guarantees to said plurality of traders.
